(19) United States
(12) Patent Application Publication
(10) Pub. No.: US 2025/0254564 A1
(43) Pub. Date: Aug. 7, 2025

(54) SYSTEMS AND METHODS FOR POLICY-BASED INTER-NETWORK NON-IP MESSAGING

(71) Applicant: Verizon Patent and Licensing Inc., Basking Ridge, NJ (US)

(72) Inventors: Ye Huang, San Ramon, CA (US); Louis Chan-Lizardo, San Ramon, CA (US); Alexander Fadeev, Summit, NJ (US); Michael R. Waters, Staten Island, NY (US)

(73) Assignee: Verizon Patent and Licensing Inc., Basking Ridge, NJ (US)

(21) Appl. No.: 18/433,627

(22) Filed: Feb. 6, 2024

(51) Int. Cl. H04W 28/08; H04W 8/18; H04W 28/02

(52) U.S. Cl. CPC H04W 28/0925; H04W 8/18; H04W 28/0215

(57) ABSTRACT

A system described herein may maintain a set of policies associated with non-Internet Protocol (“IP”) messaging; maintain information associating an IP address of a User Equipment (“UE”) with a non-IP identifier of the UE; receive first traffic, that includes the IP address of the UE as a source of the first traffic, and payload information; identify, using the maintained information associating the IP address of the UE with the non-IP identifier of the UE, the non-IP identifier of the UE based on the IP address of the UE included in the first traffic; identify that the first traffic is associated with a particular policy of the set of policies; and forward second traffic, including the payload information and the non-IP identifier of the UE, to a destination device indicated in the first traffic, where forwarding the second traffic includes implementing the particular policy with respect to the second traffic.

### BACKGROUND

Wireless networks provide wireless connectivity to User Equipment (“UEs”), such as mobile telephones, tablets, Internet of Things (“IoT”) devices, Machine-to-Machine (“M2M”) devices, or the like. Wireless networks may route messages or traffic in accordance various protocols or layers (e.g., layers of the Open Systems Interconnection (“OSI”) model), such as Internet Protocol (“IP”) messages. Some wireless networks may offer functionality for non-IP messaging, in which traffic may be sent to or from UEs without the use of an IP address that has been assigned to the UE.

### BRIEF DESCRIPTION OF THE DRAWINGS

FIG. 1 illustrates an example overview of one or more embodiments described herein;

FIG. 2 illustrates an example non-IP setup procedure, in accordance with some embodiments;

FIGS. 3 and 4 illustrate examples of implementing non-IP messaging for a UE that is connected to a visited network, in accordance with some embodiments;

FIG. 5 illustrates an example process for implementing uplink policy-based non-IP messaging, in accordance with some embodiments;

FIG. 6 illustrates an example process for implementing downlink policy-based non-IP messaging, in accordance with some embodiments;

FIGS. 7 and 8 illustrate example environments in which one or more embodiments, described herein, may be implemented;

FIG. 9 illustrates an example arrangement of a radio access network (“RAN”), in accordance with some embodiments; and

FIG. 10 illustrates example components of one or more devices, in accordance with one or more embodiments described herein.

### DETAILED DESCRIPTION OF EXAMPLE EMBODIMENTS

The following detailed description refers to the accompanying drawings. The same reference numbers in different drawings may identify the same or similar elements.

Embodiments described herein provide for a mechanism by which non-IP communications may be implemented for a UE. In accordance with some embodiments, the UE may be connected to a wireless network that is different or separate from a home network of the UE. A “home” network may be, for example, a wireless network that has provisioned, configured, provided, etc. the UE. The UE may, for example, maintain information indicating that such wireless network is a home network of the UE (e.g., may maintain a Public Land Mobile Network (“PLMN”) identifier or other suitable identifier of the home network). In accordance with some embodiments, the non-IP messaging may include using a Mobile Directory Number (“MDN”) or other identifier (e.g., other than an IP address) of the UE to send traffic to the UE via the visited network. Further, in accordance with some embodiments, the non-IP messaging may include routing traffic, received from the UE via the visited network, to a destination device (e.g., an application server, another UE, etc.) using an Access Point Name (“APN”), an MDN, or other identifier (e.g., other than an IP address) of the destination device.

The inter-network non-IP messaging of some embodiments may not require a Network Exposure Function (“NEF”), Service Capability Exposure Function (“SCEF”), or the like, to be implemented by the visited network. As discussed below, interfaces between elements of a core of the home network (e.g., a User Plane Function (“UPF”), a Packet Data Network (“PDN”) gateway (“PGW”), or the like) and elements of a core of the visited network (e.g., a Session Management Function (“SMF”), a Serving Gateway (“SGW”), or the like) may be leveraged to provide for the non-IP messaging for a UE connected to a visited network, thus avoiding the need for the visited network to provide dedicated functions or services related to non-IP messaging.

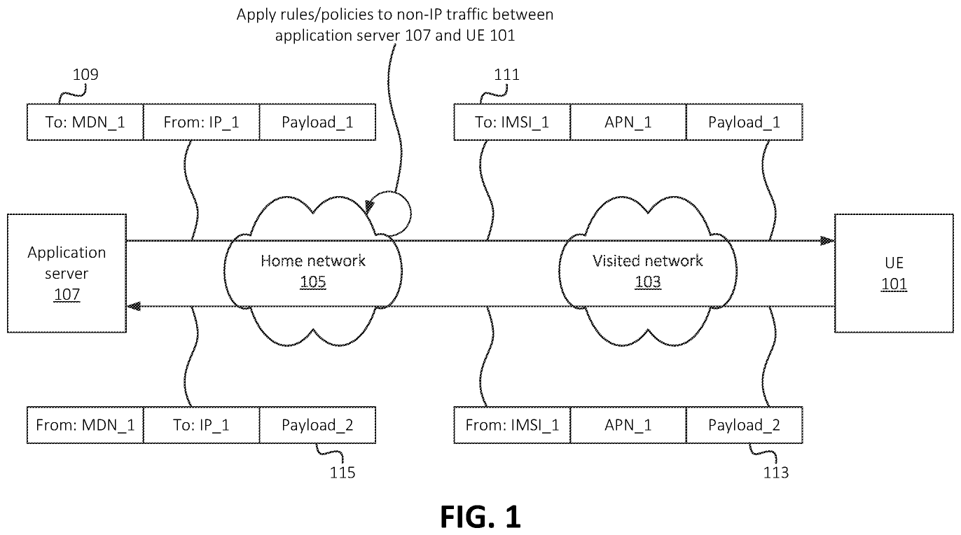

FIG. 1 illustrates an example of implementing non-IP messaging, in accordance with some embodiments, for a particular UE 101 that is connected to visited network 103. In this example, further assume that network 105 is a home network of UE 101. Networks 103 and 105 may, for example, be implemented, operated, provided, etc. by separate entities, such as different Mobile Network Operators (“MNOs”), different carriers, etc. As discussed above, UE 101 may maintain information indicating network 105 as a home network of UE 101, and/or network 105 may maintain information indicating network 105 as the home network of UE 101. As part of connecting to network 103, UE 101 may have indicated, to network 103, that network 105 is the home network of UE 101. As part of the connection of UE 101 to network 103, network 103 may communicate with network 105 to authenticate UE 101, to determine whether UE 101 is authorized to connect to network 103, or the like. In this sense, network 103 may be “aware” of network 105 (e.g., as a home network of UE 101), and network 105 may be “aware” that UE 101 is connected to network 103. UE 101 may, for example, be “roaming” or located in a service region of network 103 (e.g., outside of a service region of network 105), and/or may be connected to network 103 for some other reason.

In accordance with some embodiments, another device (e.g., application server 107) may output non-IP traffic to UE 101, via networks 103 and 105. For example, as discussed below, UE 101 and/or application server 107 may have registered with network 105 for non-IP messaging. As part of this registration, network 105 may maintain non-IP identifiers for UE 101 and/or application server 107, which may be used for non-IP messaging (e.g., in lieu of IP addresses for UE 101 and/or application server 107). For example, such non-IP identifiers may include an MDN of UE 101, an APN associated with application server 107, a unique identifier of UE 101 (e.g., an International Mobile Subscriber Identity (“IMSI”), an International Mobile Station Equipment Identity (“IMEI”), a Subscription Permanent Identifier (“SUPI”), a Globally Unique Temporary Identifier (“GUTI”), etc.), and/or other suitable non-IP identifiers used in accordance operations described below.

As shown in FIG. 1, downlink non-IP traffic 109 (e.g., one or more messages sent to UE 101) while UE 101 is connected to network 103 may be sent from application server 107 via network 105. For example, application server 107 may communicate with network 105 via an established communication session (e.g., a protocol data unit (“PDU”) session or other suitable type of communication session), and may include a non-IP identifier (e.g., an MDN) of UE 101 in a “to:” field of header information of non-IP traffic 109, and/or may otherwise indicate that an intended recipient of non-IP traffic 109 is UE 101 (e.g., without using an IP address of UE 101). In this manner, application server 107 may not need to be “aware” that UE 101 is connected to a different network than 105 (e.g., is connected to visited network 103, a roaming network, etc.), and application server 107 may be able to send non-IP traffic 109 to UE 101 whether UE 101 is connected to network 105, network 103, or some other network. Non-IP traffic 109 may include an IP address of application server 107 and/or some other suitable identifier (i.e., “IP_1” in this example), such as in a “from:” field of header information. Non-IP traffic 109 may further include a payload (i.e., “Payload_1” in this example), such as content, a message body, etc.

In accordance with some embodiments, and as described herein, network 105 may identify that the MDN indicated as the intended recipient of non-IP traffic 109 is associated with UE 101 (e.g., as opposed to other UEs 101 for which network 105 is a home network). Network 105 may (e.g., based on a registration procedure associated with UE 101) maintain information associating the MDN of UE 101 (i.e., “MDN_1” in this example) with a unique identifier of UE 101 (e.g., an IMSI, an IMEI, etc.—“IMSI_1” in this example). Network 105 may further identify (e.g., based on a registration procedure associated with application server 107) an APN (i.e., “APN_1” in this example) with which application server 107 is associated. This particular APN may, for example, indicate non-IP messaging associated with application server 107 and/or with UE 101, including downlink or uplink non-IP messaging sent to or received from UE 101 and/or non-IP messaging sent to or received from application server 107. In some embodiments, the particular APN may be associated with a particular set of Quality of Service (“QoS”) parameters, where networks 103 and/or 105 implement such QoS parameters for traffic that includes such APN.

Network 105 may generate non-IP traffic 111 that includes the payload of the original message from application server 107, and that further indicates the unique identifier of UE 101 (e.g., IMSI_1) as the intended recipient of non-IP traffic 111. Non-IP traffic 111 may also include the particular APN (e.g., APN_1) with which non-IP messaging between application server 107 and UE 101 is associated. In some embodiments, non-IP traffic 111 may include one or more other APNs in addition to APN_1 (e.g., where the other APNs may be used by networks 103 and/or 105 for QoS treatment, routing, and/or other suitable purposes).

Network 103 may further provide non-IP traffic 111 to UE 101 (e.g., via a RAN of network 103). For example, network 103 may use the IMSI of UE 101, as included in non-IP traffic 111, to route, forward, etc. non-IP traffic 111 to UE 101. UE 101 may identify a source of non-IP traffic 111 based on the APN included in non-IP traffic 111. For example, as discussed below, UE 101 may have previously received information associating the particular APN with application server 107. In accordance with some embodiments, application server 107 may thus be able to communicate with UE 101, without having knowledge or awareness of which network UE 101 is currently connected to, and without needing to establish (or re-establish) communication sessions with UE 101 when UE 101 moves from network to network (e.g., from network 105 to network 103 or vice versa).

In accordance with some embodiments, the forwarding, processing, etc. of non-IP traffic 109 from application server 107 may be performed in accordance with one or more policies, rules, etc. (e.g., filtering policies, load balancing policies, etc.), thus providing further control of the manner in which traffic is communicated between application server 107 and UE 101, when UE 101 is connected to a different network 103. In some embodiments, the policies, rules, etc. may include a policy specifying that traffic from application server 107 should be buffered for a particular duration of time, and/or that a particular quantity of messages from application server 107 should be buffered, before sending to UE 101. For example, a particular policy may indicate that UE 101 should receive traffic from application server 107 on an hourly basis (e.g., up to once per hour). In some scenarios, application server 107 may output traffic (e.g., non-IP traffic 109) to UE 101 multiple times per hour. In accordance with some embodiments, network 105 may buffer multiple non-IP messages received from application server 107, for UE 101, over the course of an hour and may output a single message (or set of messages) that includes and/or is otherwise based on the multiple messages received over the hour.

An element of network 105, with which application server 107 communicates, may be configurable inasmuch as the particular policies, rules, etc. that are applied to traffic sent between application server 107 and UE 101 may be adjusted dynamically (e.g., by an owner or operator of network 105), in order to satisfy performance thresholds, load thresholds, or other metrics that ultimately enhance the efficiency of network 105 and/or the user experience of UE 101 and/or application server 107.

As further shown in FIG. 1, non-IP messaging techniques in accordance with some embodiments may also be used for uplink communications (e.g., traffic sent by UE 101, such as non-IP traffic 113). As shown, non-IP traffic 113 may include payload information (e.g., Payload_2), and may include a non-IP identifier of UE 101 (e.g., a unique identifier of UE 101 such as IMSI_1), where such non-IP identifier indicates that UE 101 is a source of non-IP traffic 113. Non-IP traffic 113 may further include an APN (e.g., APN_1) associated with non-IP messaging between UE 101 and application server 107. The APN may be included in non-IP traffic 113 by UE 101 to indicate that the intended recipient of non-IP traffic 113 is application server 107, and/or to indicate that non-IP traffic 113 is otherwise associated with application server 107 (e.g., is associated with a service provided by application server 107).

Network 103 may forward non-IP traffic 113 to network 105. For example, network 103 may receive or maintain information indicating that network 105 is a home network of UE 101, may determine that the particular APN included in non-IP traffic 113 indicates that non-IP traffic 113 should be forwarded to network 105, and/or may otherwise determine that non-IP traffic 113 should be forwarded to network 105.

In accordance with some embodiments, and similar to the discussion above regarding downlink non-IP traffic 109 and 111, network 105 may apply rules, policies, etc. to non-IP traffic 113. For example, as discussed above, network 105 may perform filtering operations, rate limiting operations, and/or other suitable operations based on one or more rules or policies that are maintained by network 105 and that are applicable to communications (e.g., uplink non-IP communications) between UE 101 and application server 107. Network 105 may further generate non-IP traffic 115 based on non-IP traffic 113, which may include the same payload (i.e., Payload_2, in this example). Network 105 may further identify that the APN included in non-IP traffic 113 is associated with application server 107 (and/or is associated with non-IP communications between UE 101 and application server 107), and may accordingly include the IP address of application server 107 (i.e., IP_1) in non-IP traffic 115. For example, a “to” or “destination” field of header information of non-IP traffic 115 may include the IP address of application server 107. The IP address of application server 107 may be used by network 105 (e.g., by internal routing mechanisms of network 105) to route non-IP traffic 115 to application server 107. Network 105 may also identify a non-IP identifier, such as MDN_1, with which UE 101 is associated. Non-IP traffic 115 may accordingly include such identifier (e.g., MDN_1), with an indication that a source of non-IP traffic 115 is associated with such identifier (e.g., may include the MDN of UE 101 in a “from” or “source” field of header information of non-IP traffic 115). In this manner, similar to how application server 107 may use the MDN of UE 101 to send non-IP traffic 109 to UE 101, application server 107 may also identify that received non-IP traffic 115 is associated with UE 101 based on the MDN of UE 101.

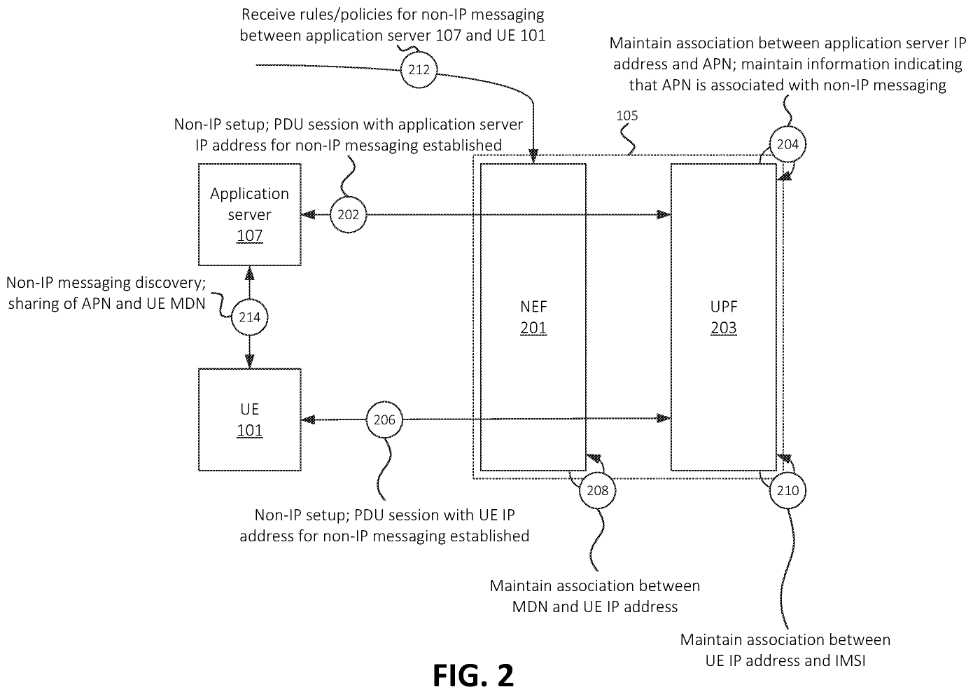

FIG. 2 illustrates an example set of registration, and/or initialization procedures, in which policy-based non-IP messaging is established between UE 101 and application server 107. As shown, application server 107 may communicate with an element of network 105 that serves as an interface between external devices, such as application server 107, and other elements of network 105. In the examples provided herein, NEF 201 may serve as the interface between application server 107 and other elements of network 105. In some embodiments, a SCEF or other suitable device or system may perform the operations described herein with respect to NEF 201.

As shown, application server 107 may participate (at 202) in a non-IP messaging setup procedure (e.g., a Non-IP Data Delivery (“NIDD”) setup procedure) with NEF 201 and/or an IP gateway of network 105, such as UPF 203. In some embodiments, a PGW or other suitable device or system may perform the operations described herein with respect to UPF 203. In some embodiments, application server 107 may output a request to NEF 201 to establish non-IP messaging for application server 107, and NEF 201 may in turn communicate with UPF 203 to establish a communication session (e.g., a protocol data unit (“PDU”) session, a tunnel, or some other suitable communication session) between application server 107 and UPF 203. NEF 201 may also generate or assign a particular APN for non-IP messaging associated with application server 107 and may indicate such APN to UPF 203, or UPF 203 may otherwise identify an APN associated with non-IP messaging associated with application server 107 (and/or non-IP messaging associated with application server 107 and one or more particular UEs, such as UE 101). The communication session (e.g., PDU session, tunnel, etc.) may be associated with one or more identifiers, such as IP addresses, for application server 107. UPF 203 may accordingly maintain (at 204) an association between the IP address of application server 107 and the APN, and may further maintain information indicating that the APN is associated with non-IP messaging.

In some embodiments, a non-IP setup procedure may also be performed (at 206) for UE 101. For example, UE 101 may communicate with NEF 201 to request a non-IP messaging setup (e.g., an NIDD setup procedure) for UE 101, and/or some other device, system, or entity (e.g., an administrator or operator of network 105 and/or UE 101) may request the non-IP messaging setup for UE 101. Similar to the non-IP setup procedure for application server 107, one or more communication sessions (e.g., PDU sessions, tunnels, etc.) may be established between UPF 203 and UE 101, where such communication sessions include an IP address for UE 101.

As part of the non-IP setup procedure (at 206) for UE 101, a non-IP identifier of UE 101 may be specified, such as an MDN of UE 101 (e.g., where a Unified Data Management function (“UDM”), Unified Data Repository (“UDR”), Home Subscriber Server (“HSS”) or other element of network 105 maintains or provides the MDN of UE 101). Specifically, for example, the non-IP identifier of UE 101 (e.g., the MDN) may be specified for use with non-IP messaging, such that non-IP messages that are directed to the non-IP identifier of UE 101 may ultimately be routed to UE 101, in accordance with some embodiments. Similarly, the MDN may be included in uplink non-IP messaging from UE 101, to identify that UE 101 is the source of such messaging. In accordance with some embodiments, NEF 201 may maintain (at 208) the association between the MDN of UE 101 and the IP address of UE 101 (e.g., the IP address used by UPF 203 to identify communications associated with UE 101, such as an IP address of UE 101 that is associated with the PDU session, tunnel, etc. between UPF 203 and UE 101).

UPF 203 may further receive or maintain (at 210) an association between the IP address of UE 101 and a second non-IP identifier of UE 101 (e.g., a unique identifier, such as an IMSI, an IMEI, etc.). As discussed below, this second non-IP identifier may be used for communications between network 105 (e.g., UPF 203) and another network 103, in situations where UE 101 is connected to network 103 (e.g., roaming scenarios or other suitable scenarios).

In some embodiments, NEF 201 may further receive (at 212) rules, policies, etc. relating to non-IP messaging between application server 107. For example, as discussed above, the rules, policies, etc. may include filtering policies, buffering policies, rate limiting policies, etc. Generally, the rules, policies, etc. may indicate how to process, queue, prioritize, and/or otherwise handle non-IP messaging between UE 101 and application server 107. For example, a particular non-IP messaging policy may specify temporal conditions, such as times of the day, days of the week, etc., during which particular policies are to be applied. For example, similar to an example discussed above, a particular policy may indicate that UE 101 should only receive non-IP traffic on an hourly basis from application server 107. In some embodiments, the particular policy may be in effect only on weekdays (e.g., Monday through Thursday).

As another example, a particular policy may indicate that traffic from application server 107 should not be sent to UE 101 when network 105 is overloaded (e.g., one or more measures of load or demand exceed one or more thresholds). As yet another example, a particular policy may indicate a maximum data size of a payload of non-IP traffic between application server 107 and UE 101. As another example, a particular policy may indicate that particular types of content (e.g., particular codecs, content that includes one or more particular words or phrases, etc.) should not be forwarded (e.g., should be dropped, rejected, etc.) as non-IP traffic to UE 101 from application server 107. Although some examples of policies are discussed above, in practice, the rules or policies received (at 212) by NEF 201 may include other suitable types of rules or policies. NEF 201 may, for example, receive such rules or policies from an administrator or operator of network 105, and/or from some other authorized source.

As further shown, UE 101 and application server 107 may perform (at 214) a non-IP messaging discovery procedure, in which UE 101 and application server 107 are both made “aware” that non-IP messaging is available between UE 101 and application server 107. For example, application server 107 may provide the APN associated with the non-IP messaging to UE 101, and/or UE 101 may provide its non-IP identifier (e.g., MDN) to application server 107. In some embodiments, UE 101 and application server 107 may implement one or more APIs, applications, etc. via which application server 107 and UE 101 share such information. In some embodiments, UE 101 may receive the APN via some other suitable mechanism, and/or application server 107 may receive the MDN of UE 101 via some other suitable mechanism.

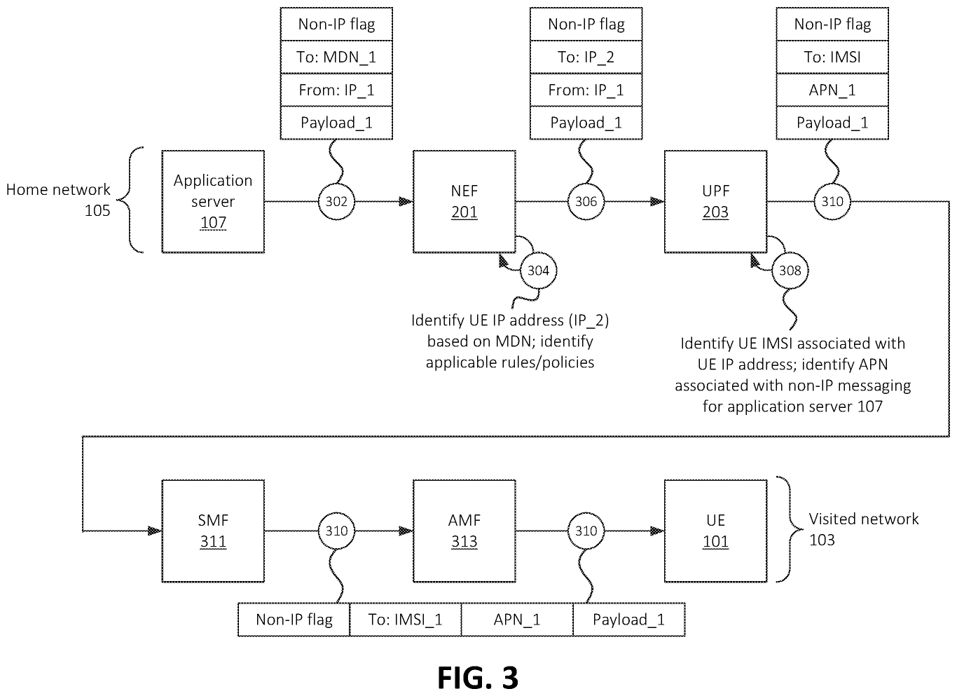

FIG. 3 illustrates an example of downlink non-IP messaging between application server 107 and UE 101 when UE 101 is connected to network 103 (e.g., a network other than home network 105 of UE 101). As shown, application server 107 may output non-IP traffic 302 to NEF 201. As similarly noted above, non-IP traffic 302 may include a non-IP identifier of UE 101, to which non-IP traffic 302 is directed. Non-IP traffic 302 may also include payload information (e.g., Payload_1), and may include the IP address of application server 107 as the source of non-IP traffic 302. In some embodiments, non-IP traffic 302 may include a flag, indicator, etc. that non-IP traffic 302 is a non-IP message. In some embodiments, non-IP traffic 302 may be encapsulated in one or more other messages between application server 107 and NEF 201. For example, non-IP traffic 302 may be encapsulated in an IP message between application server 107 and NEF 201. In this sense, NEF 201 may act as an endpoint of network 105 with which application server 107 sends and receives non-IP messages, including non-IP traffic 302.

When receiving non-IP traffic 302, NEF 201 may decapsulate, extract, etc. non-IP traffic 302 from an original message between application server 107 and NEF 201. NEF 201 may identify (at 304) an IP address of UE 101 (e.g., IP_2) that is associated with the MDN included in non-IP traffic 302. NEF 201 may further identify (at 304) a set of rules, policies, etc. associated with non-IP traffic 302. For example, NEF 201 may identify that non-IP traffic 302 is subject to a rate limiting policy, and may buffer, hold, etc. non-IP traffic 302 for some duration of time before proceeding to forward non-IP traffic 302 onward to UE 101. As another example, NEF 201 may identify that UE 101 is unreachable or that network 103 is overloaded (e.g., may receive such information from network 103 or from some other suitable source), and may buffer, hold, etc. non-IP traffic 302 until such time as UE 101 becomes reachable or network 103 becomes available (e.g., is no longer overloaded). In some embodiments, NEF 201 may perform other operations, processing, etc. of non-IP traffic 302 in accordance one or more rules or policies that are applicable to non-IP traffic 302.

NEF 201 may forward non-IP traffic 306, which is based on non-IP traffic 302, to UPF 203. Non-IP traffic 306 may include the IP address of UE 101 (e.g., IP_2, as identified at 304). In some embodiments, non-IP traffic 306 may include the IP address of UE 101 in lieu of the MDN of UE 101. That is, while application server 107 may use the MDN of UE 101 to indicate the destination of non-IP traffic 302, the MDN may be unused in subsequent operations to route non-IP traffic 302 to UE 101 (and/or other identifiers may be used to route non-IP traffic 302 to UE 101), in accordance with some embodiments. Non-IP traffic 306 may also include the non-IP payload (e.g., Payload_1) of non-IP traffic 302, and may also include the IP address of application server 107 (e.g., IP_1). In some embodiments, non-IP traffic 306 may also include a flag, indicator, etc. indicating that non-IP traffic 306 is a non-IP message.

NEF 201 may forward non-IP traffic 306 to UPF 203. In this sense, since non-IP traffic 306 includes the IP address of application server 107 as the source of non-IP traffic 306, UPF 203 may receive or process non-IP traffic 306 as if non-IP traffic 306 was received from application server 107. UPF 203 may further identify (at 308) that non-IP traffic 306 is associated with a non-IP messaging technique, based on the non-IP flag or other suitable information included in non-IP traffic 306. In some embodiments, UPF 203 may identify that non-IP traffic 306 is associated with non-IP messaging based on previously maintained information indicating that the IP address of UE 101 (e.g., IP_2) is associated with non-IP messaging. Accordingly, UPF 203 may identify (at 308) a second non-IP identifier of UE 101 (e.g., an IMSI), where the second non-IP identifier may be used by network 103 to route non-IP messages to UE 101. That is, using the second non-IP identifier may allow facilitate routing of non-IP traffic 310 to UE 101 without requiring modifications to the configuration or network 103, inasmuch as network 103 may already support messaging techniques in which the second non-IP identifier (e.g., IMSI_1) is used to route traffic to or from UE 101. UPF 203 may also identify a previously maintained APN (e.g., APN_1) associated with application server 107, and/or associated with non-IP messaging between application server 107 and UE 101.

UPF 203 may accordingly generate non-IP traffic 310 based on non-IP traffic 306 and further based on identifying (at 308) the second non-IP identifier of UE 101 (e.g., IMSI_1) and the APN associated with non-IP messaging from application server 107 and/or to UE 101 (e.g., APN_1). In this manner, non-IP traffic 310 may include the APN in lieu of (or in addition to) the IP address of application server 107, and may include the IMSI of UE 101 in lieu of (or in addition to) the IP address or MDN of UE 101.

UPF 203 may identify that UE 101 is connected to network 103 based on a registration or roaming procedure performed by elements of networks 103 and/or 105. For example, one or more elements of network 105 may receive or maintain information indicating that UE 101 is connected to network 103 (e.g., a PLMN identifier of network 103), and may accordingly be able to route communications, such as non-IP traffic 310, to network 103.

In this example, UPF 203 may, based on identifying that non-IP traffic 310 includes non-IP messaging, forward non-IP traffic 310 to SMF 311 of network 103. In some embodiments, a SGW of network 103 or other suitable device or system of network 103 may perform the operations described herein with respect to SMF 311. UPF 203 may output non-IP traffic 310 to SMF 311 via an N4 interface. In some embodiments, as discussed above, a PGW of network 105 may output non-IP traffic 310 to an SGW of network 103 via an S5-U interface. In accordance with existing standards, protocols, etc. (e.g., NIDD standards), the second non-IP identifier of UE 101 (e.g., IMSI_1) may be suitable for use by network 103 (e.g., SMF 311 and/or one or more other elements of network 103) to route non-IP traffic 310 to UE 101.

For example, SMF 311 may forward non-IP traffic 310 to a mobility and/or management element of network 103, such as AMF 313, a Mobility Management Entity (“MME”), etc. AMF 313, an MME, etc. may forward non-IP traffic 310 to UE 101 (e.g., via Non-Access Stratum (“NAS”) messaging, via an N1 interface, via an S1-MME interface, or the like). The delivery of non-IP traffic 310 may thus be done, from the standpoint of application server 107 and UE 101, without using IP addresses, thus simplifying scenarios in which the IP address of UE 101 may change (e.g., based on a change in location or connected network of UE 101). UE 101 may identify that the source of non-IP traffic 310 is application server 107, as non-IP traffic 310 includes the APN (e.g., APN_1) maintained by UE 101 as being associated with application server 107.

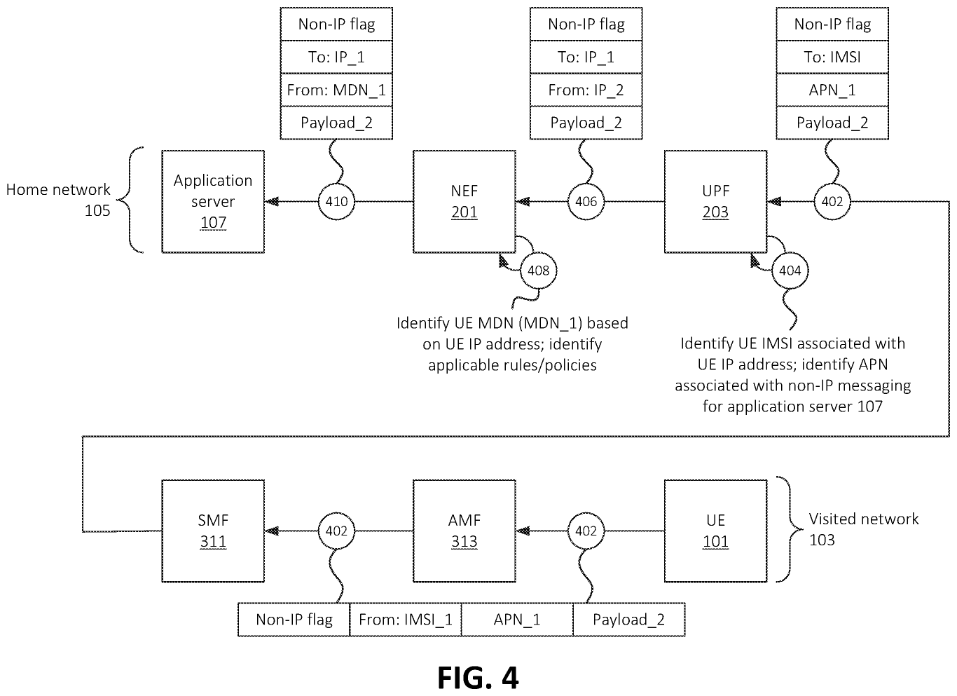

FIG. 4 illustrates an example of uplink non-IP messaging, in accordance with some embodiments. As with the example of FIG. 3, assume that UE 101 is connected to network 103, which may be a roaming network, a visited network, etc. (e.g., a network that is not a home network of UE 101). As shown, UE 101 may output non-IP traffic 402 to a mobility and/or management element of network 103, such as AMF 313, an MME, etc. Non-IP traffic 402 may be sent via, for example, NAS messaging, an N1 interface, an S1-MME interface, or the like. Non-IP traffic 402 may include a particular payload (e.g., Payload_2), may indicate a non-IP identifier of UE 101 (e.g., IMSI_1) as a source of non-IP traffic 402, and may include an APN (e.g., APN_1) for which UE 101 maintains information that such APN is associated with non-IP messaging to a particular destination (e.g., application server 107). In some embodiments, non-IP traffic 402 may include a flag, indicator, etc. that non-IP traffic 402 is associated with non-IP messaging.

AMF 313 may identify that non-IP traffic 402 is associated with non-IP messaging techniques based on, for example, the non-IP flag included in non-IP traffic 402, and/or based on identifying that the particular APN (e.g., APN_1) is associated with non-IP messaging. Based on identifying that non-IP traffic 402 is associated with a non-IP messaging technique, AMF 313 may forward non-IP traffic 402 to SMF 311 for delivery to network 105 (e.g., where AMF 313 and/or SMF 311 may receive or maintain information indicating that network 105 is the home network of UE 101, and/or that the particular APN_1 is associated with network 105). In some embodiments, in which network 103 includes an SGW (e.g., in addition to or in lieu of SMF 311), UE 101 may output 402 to the SGW (e.g., via an S1-U interface).

SMF 311 (and/or the SGW) may forward non-IP traffic 402 to network 103, such as to UPF 203, a PGW of network 105, etc. SMF 311 may, for example, identify network 105 as the destination for non-IP traffic 402 based on a mapping between the non-IP identifier of UE 101 (e.g., IMSI_1) and/or the APN (e.g., APN_1) to a PLMN identifier of network 105. UPF 203 may identify (at 404) the UE IP address (e.g., IP_2) of UE 101 based on information maintained by UPF 203 associating UE 101 with such IP address as well as with the non-IP identifier of UE 101 (e.g., IMSI_1). UPF 203 may also identify the IP address (e.g., IP_1) of application server 107, based on information maintained by UPF 203 associating the APN included in non-IP traffic 402 (e.g., APN_1) with such IP address. UPF may make such identification (at 404) based on, for example, a non-IP flag included in non-IP traffic 402, based on identifying that the APN included in non-IP traffic 402 is associated with non-IP messaging techniques, etc.

UPF 203 may generate non-IP traffic 406, which may include the same payload information (e.g., Payload_2) as non-IP traffic 402. In some embodiments, non-IP traffic 406 may be, or may be encapsulated in, an IP-based message that indicates the IP address of UE 101 (e.g., IP_2) as the source and the IP address of application server 107 (e.g., IP_1) as the destination. As shown, UPF 203 may output non-IP traffic 406 to NEF 201. For example, UPF 203 may maintain information indicating that messages with a non-IP flag (e.g., messages associated with a non-IP messaging technique) should be forwarded to NEF 201 for ultimate delivery to their intended recipients. In some embodiments, non-IP traffic 406 may also include a flag, identifier, etc. indicating that non-IP traffic 406 includes, implements, or otherwise facilitates non-IP messaging.

NEF 201 may identify (at 408) another non-IP identifier of UE 101 (e.g., MDN_1 or some other suitable non-IP identifier of UE 101 used by application server 107 for non-IP messaging with UE 101) that is associated with the IP address of UE 101. For example, as discussed above, a non-IP setup procedure may have been performed in which an association between the MDN (or other suitable non-IP identifier) and the IP address of UE 101 were established. NEF 201 may generate non-IP traffic 410, which includes the MDN of UE 101 (e.g., in lieu of the IP address of UE 101), for forwarding to application server 107 (e.g., subject to one or more applicable non-IP policies identified with respect to non-IP traffic 410).

For example, NEF 201 may identify (at 408) a set of rules, policies, etc. that are applicable to non-IP traffic 406. NEF 201 may, for instance, identify that non-IP traffic 406 should be buffered with other uplink non-IP traffic sent by UE 101 and/or other devices, in lieu of forwarding such traffic to application server 107 immediately. In accordance with some policies, NEF 201 may output buffered non-IP messages to application server 107 periodically (e.g., every minute, every hour, etc.), rather than forwarding each non-IP message to application server 107 without any such delay or buffering. As another example, NEF 201 may filter (e.g., drop) certain traffic from UE 101, such as traffic that exceeds a threshold data rate (e.g., more messages in a given time frame than a threshold quantity of messages for such time frame, a greater amount of data in a given time frame than a threshold amount of data for such time frame, etc.). As yet another example, NEF 201 may perform anti-virus or malware detection, and may selectively route some uplink non-IP traffic to application server 107, while routing other uplink non-IP traffic (e.g., traffic potentially containing viruses or otherwise posing a threat) to some other device or system, such as a “quarantined” device.

While examples of policy-based non-IP traffic processing are discussed here in the context of applying such policies to uplink non-IP traffic, similar operations may be performed (e.g., by NEF 201) with respect to downlink non-IP traffic (e.g., non-IP traffic from application server 107 to UE 101). Similarly, while examples of policy-based non-IP traffic processing are discussed above in the context of applying such policies to downlink non-IP traffic, similar operations may be performed (e.g., by NEF 201) with respect to uplink non-IP traffic. Additionally, NEF 201 may perform other types of policy-based processing, handling, etc. of non-IP traffic that are not explicitly noted herein. In this manner, non-IP messaging techniques may be further enhanced to accommodate the implementation of rules, policies, etc., thus further providing further functionality to non-IP messaging techniques, which themselves provide a mechanism for maintaining a continuous communication session with a UE that is subject to IP address changes (e.g., by moving from network to network). Further, as discussed above, these techniques provide for cross-network implementation of non-IP messaging techniques while maintaining the policy-based handling of such non-IP messaging, without requiring a visited network to perform any configuration changes or to itself implement such policies.

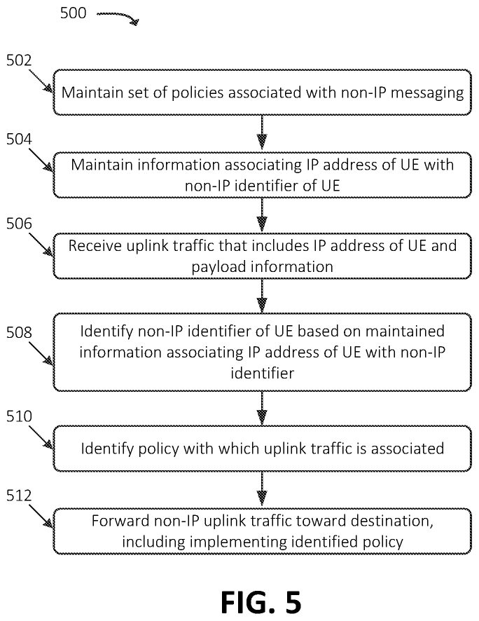

FIG. 5 illustrates an example process 500 for implementing uplink policy-based non-IP messaging, in accordance with some embodiments. In some embodiments, some or all of process 500 may be performed by NEF 201. In some embodiments, one or more other devices may perform some or all of process 500 in concert with, and/or in lieu of, NEF 201, such as a SCEF or other suitable element of a wireless network.

As shown, process 500 may include maintaining (at 502) a set of policies associated with non-IP messaging. For example, as discussed above, NEF 201 may be configured (e.g., at 212) with a set of rules, policies, conditions, etc. that are applicable to various non-IP traffic. Such rules or policies may include buffering policies, filtering policies, rate limiting policies, or the like. The types of conditions or parameters under which such polices may be dynamic and may relate to any suitable type of information that may be received or detected by NEF 201 (e.g., temporal conditions, conditions based on a location of a given UE 101, conditions relating to an amount of data sent to or received by UE 101, etc.). In this sense, the manner in which non-IP messaging is handled by NEF 201 may be configurable “on the fly” by an owner or operator of NEF 201 (e.g., a wireless network operator of network 105 that includes NEF 201). Further, the policies may be applicable to non-IP traffic that is sent to or receive from a given UE 101 while UE 101 is connected to another network 103.

Process 500 may further include maintaining (at 504) information associating an IP address of UE 101 with a non-IP identifier of the particular UE 101. For example, as discussed above, NEF 201 may maintain information associating an IP address (e.g., as generated, determined, and/or otherwise used by an IP gateway of network 103, such as UPF 203) of UE 101 with a non-IP identifier of UE 101, such as an MDN. The non-IP identifier of UE 101 may have been registered with NEF 201 as part of a non-IP setup procedure for UE 101.

Process 500 may additionally include receiving (at 506) uplink traffic that includes an IP address of UE 101 and payload information. For example, NEF 201 may receive traffic, originating from UE 101, from UPF 203. As discussed above, the traffic may have been sent by UE 101 as non-IP messaging, in which a non-IP identifier of a destination of the traffic (e.g., an APN associated with non-IP messaging for application server 107) may have been included by UE 101 in the uplink traffic. As discussed above, UPF 203 may identify that such traffic is associated with the IP address of UE 101, and may further include payload information originally included by UE 101. In some embodiments, the uplink traffic may include a flag, indicator, etc. that the uplink traffic includes or otherwise implements non-IP messaging.

Process 500 may also include identifying (at 508) a non-IP identifier of UE 101 based on the maintained (e.g., at 504) information associating the IP address of UE 101 with the non-IP identifier. For example, based on identifying that the uplink traffic includes or otherwise implements non-IP messaging, NEF 201 may identify the non-IP identifier (e.g., MDN) of UE 101 based on the maintained (e.g., at 504) information associating the IP address of UE 101 with the non-IP identifier.

Process 500 may further include identifying (at 510) a particular policy, of the set of policies (e.g., maintained at 502), with which the uplink traffic is associated. For example, NEF 201 may identify that one or more non-IP messaging policies, such as buffering policies, content filtering policies, etc. are applicable to the uplink traffic.

Process 500 may additionally include forwarding (at 512) non-IP uplink traffic toward the destination, including implementing the identified policy. For example, NEF 201 may forward the non-IP uplink traffic (e.g., which may not include the IP address of UE 101 in some embodiments) to application server 107. In this manner, application server 107 may identify that the traffic is associated with (e.g., originated from) UE 101, without needing to be “aware” of the IP address of UE 101. In situations where the IP address of UE 101 is not static (e.g., UE 101 may connect to various networks, and/or such networks may reset or change the IP address of UE 101), application server 107 may maintain end-to-end continuity of communications with UE 101 by virtue of being able to use the same non-IP identifier of UE 101 even when the IP address of UE 101 changes.

As discussed above, forwarding (at 512) the non-IP uplink traffic may further include implementing one or more policies (e.g., as identified at 510) that are applicable to the traffic. For example, NEF 201 may buffer the traffic, rate limit the traffic, combine or aggregate the traffic with other traffic, prioritize the traffic in accordance with particular QoS parameters, etc.

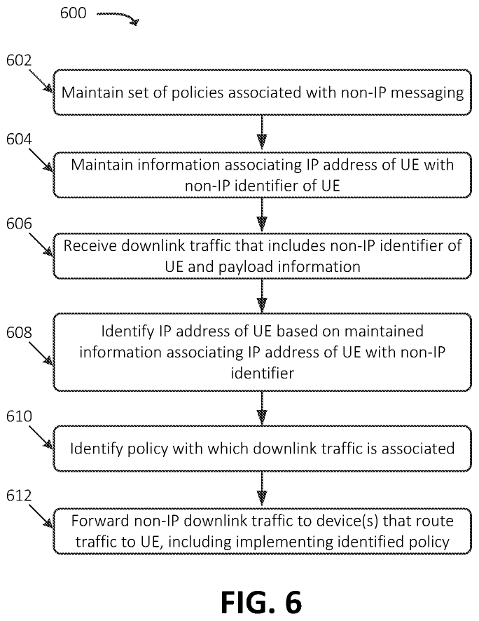

FIG. 6 illustrates an example process for implementing downlink policy-based non-IP messaging, in accordance with some embodiments. In some embodiments, some or all of process 600 may be performed by NEF 201. In some embodiments, one or more other devices may perform some or all of process 600 in concert with, and/or in lieu of, NEF 201, such as a SCEF or other suitable element of a wireless network.

As shown, process 600 may include maintaining (at 602) a set of policies associated with non-IP messaging, and maintaining (at 604) information associating an IP address of UE 101 with a non-IP identifier of the particular UE 101.

Process 600 may additionally include receiving (at 606) downlink traffic that includes a non-IP identifier of UE 101 and payload information. For example, NEF 201 may receive traffic from application server 107. As discussed above, the traffic may have been sent by application server 107 as non-IP messaging, in which a non-IP identifier of UE 101 may have been included by application server 107 in the downlink traffic. In some embodiments, the downlink traffic may include a flag, indicator, etc. that the downlink traffic includes or otherwise implements non-IP messaging.

Process 600 may also include identifying (at 608) an IP address of UE 101 based on the maintained (e.g., at 604) information associating the IP address of UE 101 with the non-IP identifier. For example, based on identifying that the downlink traffic includes or otherwise implements non-IP messaging, NEF 201 may identify the IP address of UE 101 based on the non-IP identifier (e.g., MDN) of UE 101 based on the maintained (e.g., at 604) information associating the IP address of UE 101 with the non-IP identifier.

Process 600 may further include identifying (at 610) a particular policy, of the set of policies (e.g., maintained at 602), with which the uplink traffic is associated. For example, NEF 201 may identify that one or more non-IP messaging policies, such as buffering policies, content filtering policies, etc. are applicable to the uplink traffic.

Process 600 may additionally include forwarding (at 612) non-IP downlink traffic toward to one or more devices that route traffic to UE 101, including implementing the identified policy. For example, NEF 201 may forward the non-IP downlink traffic to UPF 203. As discussed above, UPF 203 may proceed to forward the non-IP downlink traffic to SMF 311, an SGW, etc. (e.g., which may be associated with a different network 103 than a particular network 105 that includes UPF 203 and NEF 201). As also discussed above, UE 101 may ultimately receive the traffic along with another non-IP identifier (e.g., a particular APN with which application server 107 is associated), indicating that the source of the traffic is application server 107 and/or that the traffic implements a non-IP messaging technique.

In this manner, UE 101 may identify that the traffic is associated with (e.g., originated from) application server 107, without needing to be “aware” of the IP address of application server 107. In situations where the IP address of application server 107 is not static, UE 101 may maintain end-to-end continuity of communications with application server 107 by virtue of being able to use the same non-IP identifier of application server 107 even when the IP address of application server 107 changes.

As discussed above, forwarding (at 612) the non-IP downlink traffic may further include implementing one or more policies (e.g., as identified at 610) that are applicable to the traffic. For example, NEF 201 may buffer the traffic, rate limit the traffic, combine or aggregate the traffic with other traffic, prioritize the traffic in accordance with particular QoS parameters, etc.

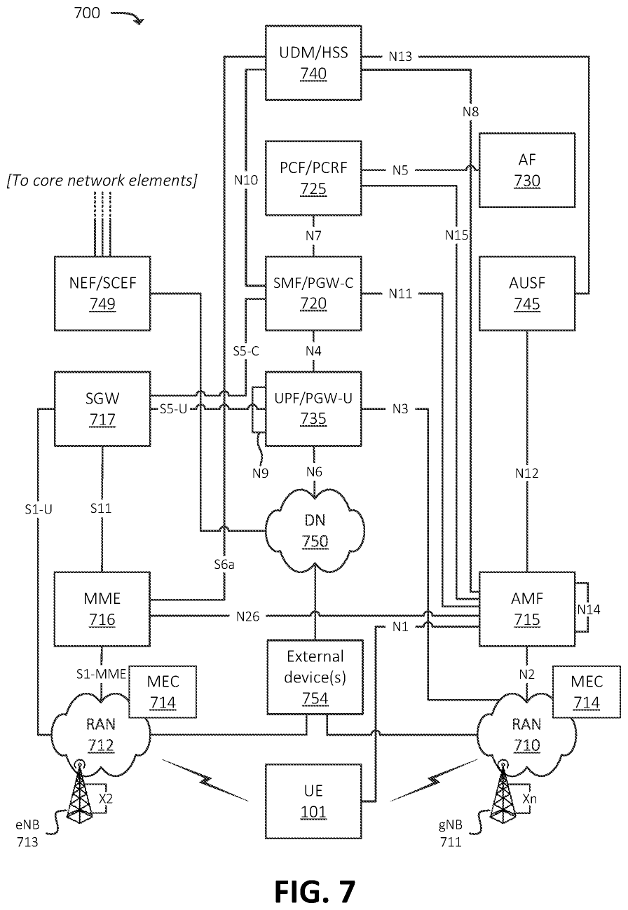

FIG. 7 illustrates an example environment 700, in which one or more embodiments may be implemented. In some embodiments, environment 700 may correspond to a Fifth Generation (“5G”) network, and/or may include elements of a 5G network. In some embodiments, environment 700 may correspond to a 5G Non-Standalone (“NSA”) architecture, in which a 5G radio access technology (“RAT”) may be used in conjunction with one or more other RATs (e.g., a Long-Term Evolution (“LTE”) RAT), and/or in which elements of a 5G core network may be implemented by, may be communicatively coupled with, and/or may include elements of another type of core network (e.g., an evolved packet core (“EPC”)). In some embodiments, portions of environment 700 may represent or may include a 5G core (“5GC”). As shown, environment 700 may include UE 101, RAN 710 (which may include one or more Next Generation Node Bs (“gNBss”) 711), RAN 712 (which may include one or more evolved Node Bs (“eNBs”) 713), and various network functions such as Access and Mobility Management Function (“AMF”) 715, Mobility Management Entity (“MME”) 716, SGW 717, SMF/PGW-Control plane function (“PGW-C”) 720, Policy Control Function (“PCF”)/Policy Charging and Rules Function (“PCRF”) 725, Application Function (“AF”) 730, User Plane Function (“UPF”)/PGW-User plane function (“PGW-U”) 735, Unified Data Management (“UDM”)/Home Subscriber Server (“HSS”) 740, Authentication Server Function (“AUSF”) 745, and NEF/SCEF 749. Environment 700 may also include one or more networks, such as Data Network (“DN”) 750. Environment 700 may include one or more additional devices or systems communicatively coupled to one or more networks (e.g., DN 750), such as one or more external devices 754.

The example shown in FIG. 7 illustrates one instance of each network component or function (e.g., one instance of SMF/PGW-C 720, PCF/PCRF 725, UPF/PGW-U 735, UDM/HSS 740, and/or AUSF 745). In practice, environment 700 may include multiple instances of such components or functions. For example, in some embodiments, environment 700 may include multiple “slices” of a core network, where each slice includes a discrete and/or logical set of network functions (e.g., one slice may include a first instance of AMF 715, SMF/PGW-C 720, PCF/PCRF 725, and/or UPF/PGW-U 735, while another slice may include a second instance of AMF 715, SMF/PGW-C 720, PCF/PCRF 725, and/or UPF/PGW-U 735). The different slices may provide differentiated levels of service, such as service in accordance with different QoS parameters.

The quantity of devices and/or networks, illustrated in FIG. 7, is provided for explanatory purposes only. In practice, environment 700 may include additional devices and/or networks, fewer devices and/or networks, different devices and/or networks, or differently arranged devices and/or networks than illustrated in FIG. 7. For example, while not shown, environment 700 may include devices that facilitate or enable communication between various components shown in environment 700, such as routers, modems, gateways, switches, hubs, etc. In some implementations, one or more devices of environment 700 may be physically integrated in, and/or may be physically attached to, one or more other devices of environment 700. Alternatively, or additionally, one or more of the devices of environment 700 may perform one or more network functions described as being performed by another one or more of the devices of environment 700.

Additionally, one or more elements of environment 700 may be implemented in a virtualized and/or containerized manner. For example, one or more of the elements of environment 700 may be implemented by one or more Virtualized Network Functions (“VNFs”), Cloud-Native Network Functions (“CNFs”), etc. In such embodiments, environment 700 may include, may implement, and/or may be communicatively coupled to an orchestration platform that provisions hardware resources, installs containers or applications, performs load balancing, and/or otherwise manages the deployment of such elements of environment 700. In some embodiments, such orchestration and/or management of such elements of environment 700 may be performed by, or in conjunction with, the open-source Kubernetes® application programming interface (“API”) or some other suitable virtualization, containerization, and/or orchestration system.

Elements of environment 700 may interconnect with each other and/or other devices via wired connections, wireless connections, or a combination of wired and wireless connections. Examples of interfaces or communication pathways between the elements of environment 700, as shown in FIG. 7, may include an N1 interface, an N2 interface, an N3 interface, an N4 interface, an N5 interface, an N6 interface, an N7 interface, an N8 interface, an N9 interface, an N10 interface, an N11 interface, an N12 interface, an N13 interface, an N14 interface, an N15 interface, an N26 interface, an S1-C interface, an S1-U interface, an S5-C interface, an S5-U interface, an S6a interface, an S11 interface, and/or one or more other interfaces. Such interfaces may include interfaces not explicitly shown in FIG. 7, such as Service-Based Interfaces (“SBIs”), including an Namf interface, an Nudm interface, an Npcf interface, an Nupf interface, an Nnef interface, an Nsmf interface, and/or one or more other SBIs. In some embodiments, environment 700 may be, may include, may be implemented by, and/or may be communicatively coupled to networks 103 and/or 105.

UE 101 may include a computation and communication device, such as a wireless mobile communication device that is capable of communicating with RAN 710, RAN 712, and/or DN 750. UE 101 may be, or may include, a radiotelephone, a personal communications system (“PCS”) terminal (e.g., a device that combines a cellular radiotelephone with data processing and data communications capabilities), a personal digital assistant (“PDA”) (e.g., a device that may include a radiotelephone, a pager, Internet/intranet access, etc.), a smart phone, a laptop computer, a tablet computer, a camera, a personal gaming system, an Internet of Things (“IoT”) device (e.g., a sensor, a smart home appliance, a wearable device, a Machine-to-Machine (“M2M”) device, or the like), a Fixed Wireless Access (“FWA”) device, or another type of mobile computation and communication device. UE 101 may send traffic to and/or receive traffic (e.g., user plane traffic) from DN 750 via RAN 710, RAN 712, and/or UPF/PGW-U 735.

RAN 710 may be, or may include, a 5G RAN that includes one or more base stations (e.g., one or more gNBs 711), via which UE 101 may communicate with one or more other elements of environment 700. UE 101 may communicate with RAN 710 via an air interface (e.g., as provided by gNB 711). For instance, RAN 710 may receive traffic (e.g., user plane traffic such as voice call traffic, data traffic, messaging traffic, etc.) from UE 101 via the air interface, and may communicate the traffic to UPF/PGW-U 735 and/or one or more other devices or networks. Further, RAN 710 may receive signaling traffic, control plane traffic, etc. from UE 101 via the air interface, and may communicate such signaling traffic, control plane traffic, etc. to AMF 715 and/or one or more other devices or networks. Additionally, RAN 710 may receive traffic intended for UE 101 (e.g., from UPF/PGW-U 735, AMF 715, and/or one or more other devices or networks) and may communicate the traffic to UE 101 via the air interface.

RAN 712 may be, or may include, a LTE RAN that includes one or more base stations (e.g., one or more eNBs 713), via which UE 101 may communicate with one or more other elements of environment 700. UE 101 may communicate with RAN 712 via an air interface (e.g., as provided by eNB 713). For instance, RAN 712 may receive traffic (e.g., user plane traffic such as voice call traffic, data traffic, messaging traffic, signaling traffic, etc.) from UE 101 via the air interface, and may communicate the traffic to UPF/PGW-U 735 (e.g., via SGW 717) and/or one or more other devices or networks. Further, RAN 712 may receive signaling traffic, control plane traffic, etc. from UE 101 via the air interface, and may communicate such signaling traffic, control plane traffic, etc. to MME 716 and/or one or more other devices or networks. Additionally, RAN 712 may receive traffic intended for UE 101 (e.g., from UPF/PGW-U 735, MME 716, SGW 717, and/or one or more other devices or networks) and may communicate the traffic to UE 101 via the air interface.

One or more RANs of environment 700 (e.g., RAN 710 and/or RAN 712) may include, may implement, and/or may otherwise be communicatively coupled to one or more edge computing devices, such as one or more Multi-Access/Mobile Edge Computing (“MEC”) devices (referred to sometimes herein simply as a “MECs”) 714. MECs 714 may be co-located with wireless network infrastructure equipment of RANs 710 and/or 712 (e.g., one or more gNBs 711 and/or one or more eNBs 713, respectively). Additionally, or alternatively, MECs 714 may otherwise be associated with geographical regions (e.g., coverage areas) of wireless network infrastructure equipment of RANs 710 and/or 712. In some embodiments, one or more MECs 714 may be implemented by the same set of hardware resources, the same set of devices, etc. that implement wireless network infrastructure equipment of RANs 710 and/or 712. In some embodiments, one or more MECs 714 may be implemented by different hardware resources, a different set of devices, etc. from hardware resources or devices that implement wireless network infrastructure equipment of RANs 710 and/or 712. In some embodiments, MECs 714 may be communicatively coupled to wireless network infrastructure equipment of RANs 710 and/or 712 (e.g., via a high-speed and/or low-latency link such as a physical wired interface, a high-speed and/or low-latency wireless interface, or some other suitable communication pathway).

MECs 714 may include hardware resources (e.g., configurable or provisionable hardware resources) that may be configured to provide services and/or otherwise process traffic to and/or from UE 101, via RAN 710 and/or 712. For example, RAN 710 and/or 712 may route some traffic from UE 101 (e.g., traffic associated with one or more particular services, applications, application types, etc.) to a respective MEC 714 instead of to core network elements of 700 (e.g., UPF/PGW-U 735). MEC 714 may accordingly provide services to UE 101 by processing such traffic, performing one or more computations based on the received traffic, and providing traffic to UE 101 via RAN 710 and/or 712. MEC 714 may include, and/or may implement, some or all of the functionality described above with respect to UPF/PGW-U 735, AF 730, one or more application servers, and/or one or more other devices, systems, VNFs, CNFs, etc. In this manner, ultra-low latency services may be provided to UE 101, as traffic does not need to traverse links (e.g., backhaul links) between RAN 710 and/or 712 and the core network.

AMF 715 may include one or more devices, systems, VNFs, CNFs, etc., that perform operations to register UE 101 with the 5G network, to establish bearer channels associated with a session with UE 101, to hand off UE 101 from the 5G network to another network, to hand off UE 101 from the other network to the 5G network, manage mobility of UE 101 between RANs 710 and/or gNBs 711, and/or to perform other operations. In some embodiments, the 5G network may include multiple AMFs 715, which communicate with each other via the N14 interface (denoted in FIG. 7 by the line marked “N14” originating and terminating at AMF 715).

MME 716 may include one or more devices, systems, VNFs, CNFs, etc., that perform operations to register UE 101 with the EPC, to establish bearer channels associated with a session with UE 101, to hand off UE 101 from the EPC to another network, to hand off UE 101 from another network to the EPC, manage mobility of UE 101 between RANs 712 and/or eNBs 713, and/or to perform other operations.

SGW 717 may include one or more devices, systems, VNFs, CNFs, etc., that aggregate traffic received from one or more eNBs 713 and send the aggregated traffic to an external network or device via UPF/PGW-U 735. Additionally, SGW 717 may aggregate traffic received from one or more UPF/PGW-Us 735 and may send the aggregated traffic to one or more eNBs 713. SGW 717 may operate as an anchor for the user plane during inter-eNB handovers and as an anchor for mobility between different telecommunication networks or RANs (e.g., RANs 710 and 712).

SMF/PGW-C 720 may include one or more devices, systems, VNFs, CNFs, etc., that gather, process, store, and/or provide information in a manner described herein. SMF/PGW-C 720 may, for example, facilitate the establishment of communication sessions on behalf of UE 101. In some embodiments, the establishment of communications sessions may be performed in accordance with one or more policies provided by PCF/PCRF 725.

PCF/PCRF 725 may include one or more devices, systems, VNFs, CNFs, etc., that aggregate information to and from the 5G network and/or other sources. PCF/PCRF 725 may receive information regarding policies and/or subscriptions from one or more sources, such as subscriber databases and/or from one or more users (such as, for example, an administrator associated with PCF/PCRF 725).

AF 730 may include one or more devices, systems, VNFs, CNFs, etc., that receive, store, and/or provide information that may be used in determining parameters (e.g., quality of service parameters, charging parameters, or the like) for certain applications.

UPF/PGW-U 735 may include one or more devices, systems, VNFs, CNFs, etc., that receive, store, and/or provide data (e.g., user plane data). For example, UPF/PGW-U 735 may receive user plane data (e.g., voice call traffic, data traffic, etc.), destined for UE 101, from DN 750, and may forward the user plane data toward UE 101 (e.g., via RAN 710, SMF/PGW-C 720, and/or one or more other devices). In some embodiments, multiple instances of UPF/PGW-U 735 may be deployed (e.g., in different geographical locations), and the delivery of content to UE 101 may be coordinated via the N9 interface (e.g., as denoted in FIG. 7 by the line marked “N9” originating and terminating at UPF/PGW-U 735). Similarly, UPF/PGW-U 735 may receive traffic from UE 101 (e.g., via RAN 710, RAN 712, SMF/PGW-C 720, and/or one or more other devices), and may forward the traffic toward DN 750. In some embodiments, UPF/PGW-U 735 may communicate (e.g., via the N4 interface) with SMF/PGW-C 720, regarding user plane data processed by UPF/PGW-U 735.

UDM/HSS 740 and AUSF 745 may include one or more devices, systems, VNFs, CNFs, etc., that manage, update, and/or store, in one or more memory devices associated with AUSF 745 and/or UDM/HSS 740, profile information associated with a subscriber. In some embodiments, UDM/HSS 740 may include, may implement, may be communicatively coupled to, and/or may otherwise be associated with some other type of repository or database, such as a Unified Data Repository (“UDR”). AUSF 745 and/or UDM/HSS 740 may perform authentication, authorization, and/or accounting operations associated with one or more UEs 101 and/or one or more communication sessions associated with one or more UEs 101.

DN 750 may include one or more wired and/or wireless networks. For example, DN 750 may include an Internet Protocol (“IP”)-based PDN, a wide area network (“WAN”) such as the Internet, a private enterprise network, and/or one or more other networks. UE 101 may communicate, through DN 750, with data servers, other UEs 101, and/or to other servers or applications that are coupled to DN 750. DN 750 may be connected to one or more other networks, such as a public switched telephone network (“PSTN”), a PLMN, and/or another network. DN 750 may be connected to one or more devices, such as content providers, applications, web servers, and/or other devices, with which UE 101 may communicate.

External devices 754 may include one or more devices or systems that communicate with UE 101 via 750 and one or more elements of 700 (e.g., via UPF/PGW-U 735). External devices 754 may include, for example, one or more application servers 107, content provider systems, web servers, or the like. External devices 754 may, for example, implement “server-side” applications that communicate with “client-side” applications executed by UE 101. External devices 754 may provide services to UE 101 such as gaming services, videoconferencing services, messaging services, email services, web services, and/or other types of services.

In some embodiments, external devices 754 may communicate with one or more elements of environment 700 (e.g., core network elements) via NEF/SCEF 749. NEF/SCEF 749 include one or more devices, systems, VNFs, CNFs, etc. that provide access to information, APIs, and/or other operations or mechanisms of one or more core network elements to devices or systems that are external to the core network (e.g., to external device 754 via DN 750). NEF/SCEF 749 may maintain authorization and/or authentication information associated with such external devices or systems, such that NEF/SCEF 749 is able to provide information, that is authorized to be provided, to the external devices or systems. For example, a given external device 754 may request particular information associated with one or more core network elements. NEF/SCEF 749 may authenticate the request and/or otherwise verify that external device 754 is authorized to receive the information, and may request, obtain, or otherwise receive the information from the one or more core network elements. In some embodiments, NEF/SCEF 749 may include, may implement, may be implemented by, may be communicatively coupled to, and/or may otherwise be associated with a Security Edge Protection Proxy (“SEPP”), which may perform some or all of the functions discussed above. External device 754 may, in some situations, subscribe to particular types of requested information provided by the one or more core network elements, and the one or more core network elements may provide (e.g., “push”) the requested information to NEF/SCEF 749 (e.g., in a periodic or otherwise ongoing basis).

In some embodiments, external devices 754 may communicate with one or more elements of RAN 710 and/or 712 via an API or other suitable interface. For example, a given external device 754 may provide instructions, requests, etc. to RAN 710 and/or 712 to provide one or more services via one or more respective MECs 714. In some embodiments, such instructions, requests, etc. may include QoS parameters, Service Level Agreements (“SLAs”), etc. (e.g., maximum latency thresholds, minimum throughput thresholds, etc.) associated with the services.

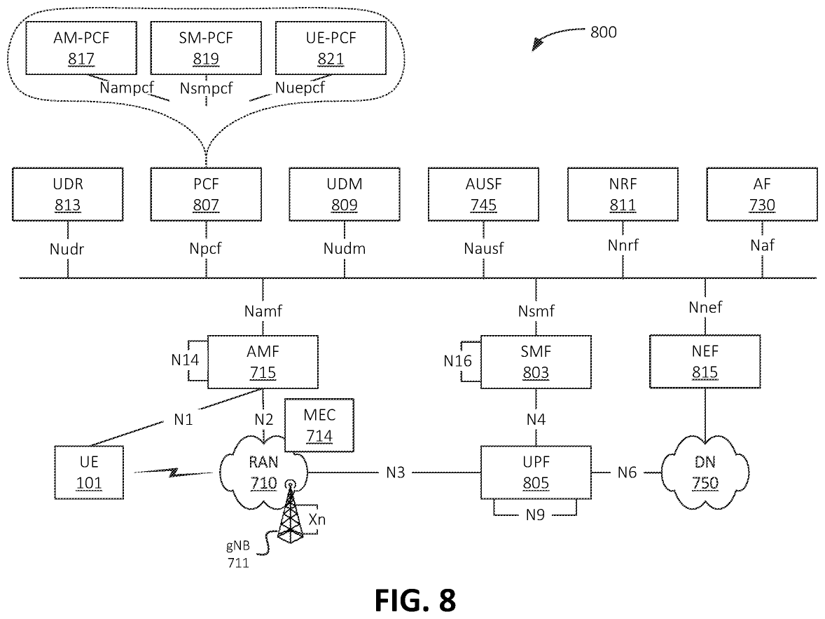

FIG. 8 illustrates another example environment 800, in which one or more embodiments may be implemented. In some embodiments, environment 800 may correspond to a 5G network, and/or may include elements of a 5G network. In some embodiments, environment 800 may correspond to a 5G SA architecture. In some embodiments, environment 800 may include a 5GC, in which 5GC network elements perform one or more operations described herein.

As shown, environment 800 may include UE 101, RAN 710 (which may include one or more gNBs 711 or other types of wireless network infrastructure) and various network functions, which may be implemented as VNFs, CNFs, etc. Such network functions may include AMF 715, SMF 803, UPF 805, PCF 807, UDM 809, AUSF 745, Network Repository Function (“NRF”) 811, AF 730, UDR 813, and NEF 815. Environment 800 may also include or may be communicatively coupled to one or more networks, such as Data Network DN 750.

The example shown in FIG. 8 illustrates one instance of each network component or function (e.g., one instance of SMF 803, UPF 805, PCF 807, UDM 809, AUSF 745, etc.). In practice, environment 800 may include multiple instances of such components or functions. For example, in some embodiments, environment 800 may include multiple “slices” of a core network, where each slice includes a discrete and/or logical set of network functions (e.g., one slice may include a first instance of SMF 803, PCF 807, UPF 805, etc., while another slice may include a second instance of SMF 803, PCF 807, UPF 805, etc.). Additionally, or alternatively, one or more of the network functions of environment 800 may implement multiple network slices. The different slices may provide differentiated levels of service, such as service in accordance with different QoS parameters.

The quantity of devices and/or networks, illustrated in FIG. 8, is provided for explanatory purposes only. In practice, environment 800 may include additional devices and/or networks, fewer devices and/or networks, different devices and/or networks, or differently arranged devices and/or networks than illustrated in FIG. 8. For example, while not shown, environment 800 may include devices that facilitate or enable communication between various components shown in environment 800, such as routers, modems, gateways, switches, hubs, etc. In some implementations, one or more devices of environment 800 may be physically integrated in, and/or may be physically attached to, one or more other devices of environment 800. Alternatively, or additionally, one or more of the devices of environment 800 may perform one or more network functions described as being performed by another one or more of the devices of environment 800.

Elements of environment 800 may interconnect with each other and/or other devices via wired connections, wireless connections, or a combination of wired and wireless connections. Examples of interfaces or communication pathways between the elements of environment 800, as shown in FIG. 8, may include interfaces shown in FIG. 8 and/or one or more interfaces not explicitly shown in FIG. 8. These interfaces may include interfaces between specific network functions, such as an N1 interface, an N2 interface, an N3 interface, an N6 interface, an N9 interface, an N14 interface, an N16 interface, and/or one or more other interfaces. In some embodiments, one or more elements of environment 800 may communicate via a service-based architecture (“SBA”), in which a routing mesh or other suitable routing mechanism may route communications to particular network functions based on interfaces or identifiers associated with such network functions. Such interfaces may include or may be referred to as SBIs, including an Namf interface (e.g., indicating communications to be routed to AMF 715), an Nudm interface (e.g., indicating communications to be routed to UDM 809), an Npcf interface, an Nupf interface, an Nnef interface, an Nsmf interface, an Nnrf interface, an Nudr interface, an Naf interface, and/or one or more other SBIs. In some embodiments, environment 800 may be, may include, may be implemented by, and/or may be communicatively coupled to networks 103 and/or 105.

UPF 805 may include one or more devices, systems, VNFs, CNFs, etc., that receive, route, process, and/or forward traffic (e.g., user plane traffic). As discussed above, UPF 805 may communicate with UE 101 via one or more communication sessions, such as PDU sessions. Such PDU sessions may be associated with a particular network slice or other suitable QoS parameters, as noted above. UPF 805 may receive downlink user plane traffic (e.g., voice call traffic, data traffic, etc. destined for UE 101) from DN 750, and may forward the downlink user plane traffic toward UE 101 (e.g., via RAN 710). In some embodiments, multiple UPFs 805 may be deployed (e.g., in different geographical locations), and the delivery of content to UE 101 may be coordinated via the N9 interface. Similarly, UPF 805 may receive uplink traffic from UE 101 (e.g., via RAN 710), and may forward the traffic toward DN 750. In some embodiments, UPF 805 may implement, may be implemented by, may be communicatively coupled to, and/or may otherwise be associated with UPF/PGW-U 735. In some embodiments, UPF 805 may communicate (e.g., via the N4 interface) with SMF 803, regarding user plane data processed by UPF 805 (e.g., to provide analytics or reporting information, to receive policy and/or authorization information, etc.).

PCF 807 may include one or more devices, systems, VNFs, CNFs, etc., that aggregate, derive, generate, etc. policy information associated with the 5GC and/or UEs 101 that communicate via the 5GC and/or RAN 710. PCF 807 may receive information regarding policies and/or subscriptions from one or more sources, such as subscriber databases (e.g., UDM 809, UDR 813, etc.), and/or from one or more users such as, for example, an administrator associated with PCF 807. In some embodiments, the functionality of PCF 807 may be split into multiple network functions or subsystems, such as access and mobility PCF (“AM-PCF”) 817, session management PCF (“SM-PCF”) 819, UE PCF (“UE-PCF”) 821, and so on. Such different “split” PCFs may be associated with respective SBIs (e.g., AM-PCF 817 may be associated with an Nampcf SBI, SM-PCF 819 may be associated with an Nsmpcf SBI, UE-PCF 821 may be associated with an Nuepcf SBI, and so on) via which other network functions may communicate with the split PCFs. The split PCFs may maintain information regarding policies associated with different devices, systems, and/or network functions.

NRF 811 may include one or more devices, systems, VNFs, CNFs, etc. that maintain routing and/or network topology information associated with the 5GC. For example, NRF 811 may maintain and/or provide IP addresses of one or more network functions, routes associated with one or more network functions, discovery and/or mapping information associated with particular network functions or network function instances (e.g., whereby such discovery and/or mapping information may facilitate the SBA), and/or other suitable information.

UDR 813 may include one or more devices, systems, VNFs, CNFs, etc. that provide user and/or subscriber information, based on which PCF 807 and/or other elements of environment 800 may determine access policies, QoS policies, charging policies, or the like. In some embodiments, UDR 813 may receive such information from UDM 809 and/or one or more other sources.

NEF 815 include one or more devices, systems, VNFs, CNFs, etc. that provide access to information, APIs, and/or other operations or mechanisms of the 5GC to devices or systems that are external to the 5GC. NEF 815 may maintain authorization and/or authentication information associated with such external devices or systems, such that NEF 815 is able to provide information, that is authorized to be provided, to the external devices or systems. Such information may be received from other network functions of the 5GC (e.g., as authorized by an administrator or other suitable entity associated with the 5GC), such as SMF 803, UPF 805, a charging function (“CHF”) of the 5GC, and/or other suitable network function. NEF 815 may communicate with external devices or systems (e.g., external devices 754) via DN 750 and/or other suitable communication pathways.

While environment 800 is described in the context of a 5GC, as noted above, environment 800 may, in some embodiments, include or implement one or more other types of core networks. For example, in some embodiments, environment 800 may be or may include a converged packet core, in which one or more elements may perform some or all of the functionality of one or more 5GC network functions and/or one or more EPC network functions. For example, in some embodiments, AMF 715 may include, may implement, may be implemented by, and/or may otherwise be associated with MME 716; SMF 803 may include, may implement, may be implemented by, and/or may otherwise be associated with SGW 717; PCF 807 may include, may implement, may be implemented by, and/or may otherwise be associated with a PCRF (e.g., PCF/PCRF 725); NEF 815 may include, may implement, may be implemented by, and/or may otherwise be associated with a SCEF (e.g., NEF/SCEF 749); and so on.

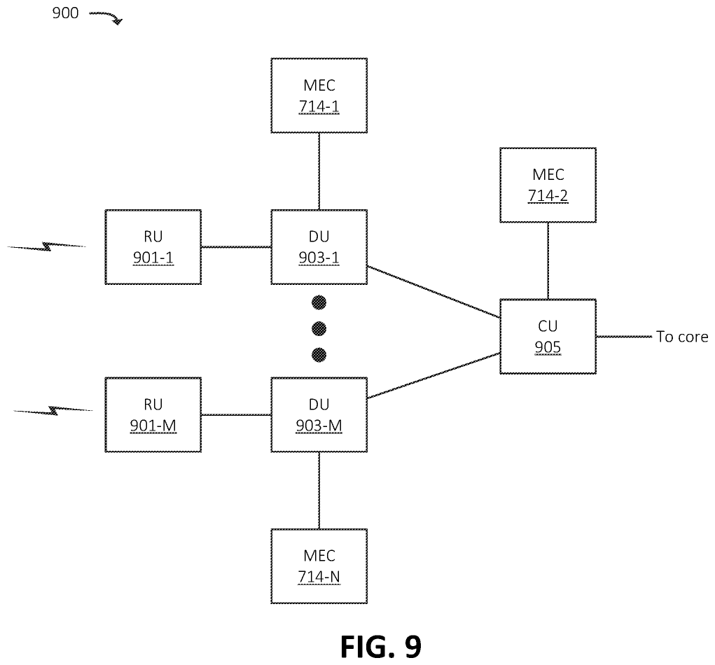

FIG. 9 illustrates an example RAN environment 900, which may be included in and/or implemented by one or more RANs (e.g., RAN 710 or some other RAN). In some embodiments, a particular RAN 710 may include one RAN environment 900. In some embodiments, a particular RAN 710 may include multiple RAN environments 900. In some embodiments, RAN environment 900 may correspond to a particular gNB 711 of RAN 710. In some embodiments, RAN environment 900 may correspond to multiple gNBs 711. In some embodiments, RAN environment 900 may correspond to one or more other types of base stations of one or more other types of RANs. As shown, RAN environment 900 may include Central Unit (“CU”) 905, one or more Distributed Units (“DUs”) 903-1 through 903-N (referred to individually as “DU 903,” or collectively as “DUs 903”), and one or more Radio Units (“RUs”) 901-1 through 901-M (referred to individually as “RU 901,” or collectively as “RUs 901”).

CU 905 may communicate with a core of a wireless network (e.g., may communicate with one or more of the devices or systems described above with respect to FIG. 8, such as AMF 715 and/or UPF 805). In the uplink direction (e.g., for traffic from UEs 101 to a core network), CU 905 may aggregate traffic from DUs 903, and forward the aggregated traffic to the core network. In some embodiments, CU 905 may receive traffic according to a given protocol (e.g., Radio Link Control (“RLC”)) from DUs 903, and may perform higher-layer processing (e.g., may aggregate/process RLC packets and generate Packet Data Convergence Protocol (“PDCP”) packets based on the RLC packets) on the traffic received from DUs 903.

In accordance with some embodiments, CU 905 may receive downlink traffic (e.g., traffic from the core network) for a particular UE 101, and may determine which DU(s) 903 should receive the downlink traffic. DU 903 may include one or more devices that transmit traffic between a core network (e.g., via CU 905) and UE 101 (e.g., via a respective RU 901). DU 903 may, for example, receive traffic from RU 901 at a first layer (e.g., physical (“PHY”) layer traffic, or lower PHY layer traffic), and may process/aggregate the traffic to a second layer (e.g., upper PHY and/or RLC). DU 903 may receive traffic from CU 905 at the second layer, may process the traffic to the first layer, and provide the processed traffic to a respective RU 901 for transmission to UE 101.

RU 901 may include hardware circuitry (e.g., one or more RF transceivers, antennas, radios, and/or other suitable hardware) to communicate wirelessly (e.g., via an RF interface) with one or more UEs 101, one or more other DUs 903 (e.g., via RUs 901 associated with DUs 903), and/or any other suitable type of device. In the uplink direction, RU 901 may receive traffic from UE 101 and/or another DU 903 via the RF interface and may provide the traffic to DU 903. In the downlink direction, RU 901 may receive traffic from DU 903, and may provide the traffic to UE 101 and/or another DU 903.

One or more elements of RAN environment 900 may, in some embodiments, be communicatively coupled to one or more MECs 714. For example, DU 903-1 may be communicatively coupled to MEC 714-1, DU 903-N may be communicatively coupled to MEC 714-N, CU 905 may be communicatively coupled to MEC 714-2, and so on. MECs 714 may include hardware resources (e.g., configurable or provisionable hardware resources) that may be configured to provide services and/or otherwise process traffic to and/or from UE 101, via a respective RU 901.

For example, DU 903-1 may route some traffic, from UE 101, to MEC 714-1 instead of to a core network via CU 905. MEC 714-1 may process the traffic, perform one or more computations based on the received traffic, and may provide traffic to UE 101 via RU 901-1. As discussed above, MEC 714 may include, and/or may implement, some or all of the functionality described above with respect to UPF 805, AF 730, and/or one or more other devices, systems, VNFs, CNFs, etc. In this manner, ultra-low latency services may be provided to UE 101, as traffic does not need to traverse DU 903, CU 905, links between DU 903 and CU 905, and an intervening backhaul network between RAN environment 900 and the core network.

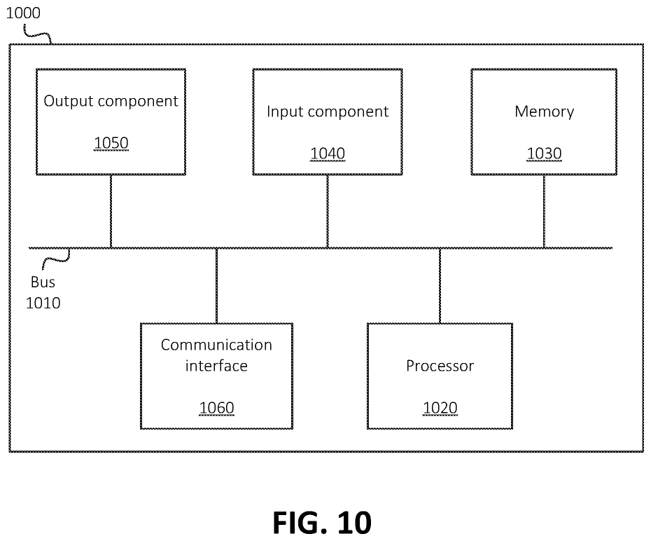

FIG. 10 illustrates example components of device 1000. One or more of the devices described above may include one or more devices 1000. Device 1000 may include bus 1010, processor 1020, memory 1030, input component 1040, output component 1050, and communication interface 1060. In another implementation, device 1000 may include additional, fewer, different, or differently arranged components.

Bus 1010 may include one or more communication paths that permit communication among the components of device 1000. Processor 1020 may include a processor, microprocessor, a set of provisioned hardware resources of a cloud computing system, or other suitable type of hardware that interprets and/or executes instructions (e.g., processor-executable instructions). In some embodiments, processor 1020 may be or may include one or more hardware processors. Memory 1030 may include any type of dynamic storage device that may store information and instructions for execution by processor 1020, and/or any type of non-volatile storage device that may store information for use by processor 1020.

Input component 1040 may include a mechanism that permits an operator to input information to device 1000 and/or other receives or detects input from a source external to input component 1040, such as a touchpad, a touchscreen, a keyboard, a keypad, a button, a switch, a microphone or other audio input component, etc. In some embodiments, input component 1040 may include, or may be communicatively coupled to, one or more sensors, such as a motion sensor (e.g., which may be or may include a gyroscope, accelerometer, or the like), a location sensor (e.g., a Global Positioning System (“GPS”)-based location sensor or some other suitable type of location sensor or location determination component), a thermometer, a barometer, and/or some other type of sensor. Output component 1050 may include a mechanism that outputs information to the operator, such as a display, a speaker, one or more light emitting diodes (“LEDs”), etc.

Communication interface 1060 may include any transceiver-like mechanism that enables device 1000 to communicate with other devices and/or systems (e.g., via RAN 710, RAN 712, DN 750, etc.). For example, communication interface 1060 may include an Ethernet interface, an optical interface, a coaxial interface, or the like. Communication interface 1060 may include a wireless communication device, such as an infrared (“IR”) receiver, a Bluetooth® radio, or the like. The wireless communication device may be coupled to an external device, such as a cellular radio, a remote control, a wireless keyboard, a mobile telephone, etc. In some embodiments, device 1000 may include more than one communication interface 1060. For instance, device 1000 may include an optical interface, a wireless interface, an Ethernet interface, and/or one or more other interfaces.

Device 1000 may perform certain operations relating to one or more processes described above. Device 1000 may perform these operations in response to processor 1020 executing instructions, such as software instructions, processor-executable instructions, etc. stored in a computer-readable medium, such as memory 1030. A computer-readable medium may be defined as a non-transitory memory device. A memory device may include space within a single physical memory device or spread across multiple physical memory devices. The instructions may be read into memory 1030 from another computer-readable medium or from another device. The instructions stored in memory 1030 may be processor-executable instructions that cause processor 1020 to perform processes described herein. Alternatively, hardwired circuitry may be used in place of or in combination with software instructions to implement processes described herein. Thus, implementations described herein are not limited to any specific combination of hardware circuitry and software.

The foregoing description of implementations provides illustration and description, but is not intended to be exhaustive or to limit the possible implementations to the precise form disclosed. Modifications and variations are possible in light of the above disclosure or may be acquired from practice of the implementations.

For example, while series of blocks and/or signals have been described above (e.g., with regard to FIGS. 1-6), the order of the blocks and/or signals may be modified in other implementations. Further, non-dependent blocks and/or signals may be performed in parallel. Additionally, while the figures have been described in the context of particular devices performing particular acts, in practice, one or more other devices may perform some or all of these acts in lieu of, or in addition to, the above-mentioned devices.

The actual software code or specialized control hardware used to implement an embodiment is not limiting of the embodiment. Thus, the operation and behavior of the embodiment has been described without reference to the specific software code, it being understood that software and control hardware may be designed based on the description herein.

In the preceding specification, various example embodiments have been described with reference to the accompanying drawings. It will, however, be evident that various modifications and changes may be made thereto, and additional embodiments may be implemented, without departing from the broader scope of the invention as set forth in the claims that follow. The specification and drawings are accordingly to be regarded in an illustrative rather than restrictive sense.

Even though particular combinations of features are recited in the claims and/or disclosed in the specification, these combinations are not intended to limit the disclosure of the possible implementations. In fact, many of these features may be combined in ways not specifically recited in the claims and/or disclosed in the specification. Although each dependent claim listed below may directly depend on only one other claim, the disclosure of the possible implementations includes each dependent claim in combination with every other claim in the claim set.

Further, while certain connections or devices are shown, in practice, additional, fewer, or different, connections or devices may be used. Furthermore, while various devices and networks are shown separately, in practice, the functionality of multiple devices may be performed by a single device, or the functionality of one device may be performed by multiple devices. Further, multiple ones of the illustrated networks may be included in a single network, or a particular network may include multiple networks. Further, while some devices are shown as communicating with a network, some such devices may be incorporated, in whole or in part, as a part of the network.

To the extent the aforementioned implementations collect, store, or employ personal information of individuals, groups or other entities, it should be understood that such information shall be used in accordance with all applicable laws concerning protection of personal information. Additionally, the collection, storage, and use of such information can be subject to consent of the individual to such activity, for example, through well known “opt-in” or “opt-out” processes as can be appropriate for the situation and type of information. Storage and use of personal information can be in an appropriately secure manner reflective of the type of information, for example, through various access control, encryption and anonymization techniques for particularly sensitive information.

No element, act, or instruction used in the present application should be construed as critical or essential unless explicitly described as such. An instance of the use of the term “and,” as used herein, does not necessarily preclude the interpretation that the phrase “and/or” was intended in that instance. Similarly, an instance of the use of the term “or,” as used herein, does not necessarily preclude the interpretation that the phrase “and/or” was intended in that instance. Also, as used herein, the article “a” is intended to include one or more items, and may be used interchangeably with the phrase “one or more.” Where only one item is intended, the terms “one,” “single,” “only,” or similar language is used. Further, the phrase “based on” is intended to mean “based, at least in part, on” unless explicitly stated otherwise.

What is claimed is:

1. A device, comprising:
one or more processors configured to:
maintain a set of policies associated with non-Internet Protocol (“IP”) messaging;
maintain information associating an IP address of a User Equipment (“UE”) with a non-IP identifier of the UE;
receive first traffic, that includes:
the IP address of the UE as a source of the first traffic, and
payload information;
identify, using the maintained information associating the IP address of the UE with the non-IP identifier of the UE, the non-IP identifier of the UE based on the IP address of the UE included in the first traffic;
identify that the first traffic is associated with a particular policy of the set of policies; and
forward second traffic, including the payload information and the non-IP identifier of the UE, to a destination device indicated in the first traffic,
wherein forwarding the second traffic includes implementing the particular policy with respect to the second traffic.

2. The device of claim 1, wherein implementing the particular policy includes buffering the second traffic with other traffic received over a particular time window, and forwarding the second traffic and the other traffic after the particular time window has elapsed.

3. The device of claim 1, wherein implementing the particular policy includes performing a filtering operation on the first or second traffic.

4. The device of claim 1, wherein the non-IP identifier of the UE includes a Mobile Directory Number (“MDN”) of the UE.

5. The device of claim 1, wherein the first traffic is received from at least one of:
a User Plane Function (“UPF”), or
a Packet Data Network (“PDN”) gateway (“PGW”).

6. The device of claim 5, wherein the non-IP identifier of the UE is a first non-IP identifier, wherein the UPF or the PGW identify the IP address of the UE based on information associating a second non-IP identifier of the UE with the IP address of the UE.

7. The device of claim 6, wherein the second non-IP identifier includes at least one of:
an International Mobile Subscriber Identity (“IMSI”),
an International Mobile Station Equipment Identity (“IMEI”),
a Subscription Permanent Identifier (“SUPI”), or
a Globally Unique Temporary Identifier (“GUTI”).

8. A device, comprising:
one or more processors configured to:
maintain a set of policies associated with non-Internet Protocol (“IP”) messaging;
maintain information associating an IP address of a User Equipment (“UE”) with a non-IP identifier of the UE;
receive first traffic, that includes:
the non-IP identifier of the UE as a destination of the first traffic, and
payload information;
identify, using the maintained information associating the IP address of the UE with the non-IP identifier of the UE, the IP address of the UE based on the non-IP identifier included in the first traffic;
identify that the first traffic is associated with a particular policy of the set of policies; and
forward second traffic, including the payload information and the IP address of the UE, to one or more devices that route the second traffic to the UE,
wherein forwarding the second traffic includes implementing the particular policy with respect to the second traffic.

9. The device of claim 8, wherein implementing the particular policy includes buffering the second traffic with other traffic received over a particular time window, and forwarding the second traffic and the other traffic after the particular time window has elapsed.

10. The device of claim 8, wherein implementing the particular policy includes performing a filtering operation on the first or second traffic.

11. The device of claim 8, wherein the non-IP identifier of the UE includes a Mobile Directory Number (“MDN”) of the UE.

12. The device of claim 8, wherein forwarding the second traffic includes forwarding the second traffic to at least one of:
a User Plane Function (“UPF”), or
a Packet Data Network (“PDN”) gateway (“PGW”).

13. The device of claim 12, wherein the non-IP identifier of the UE is a first non-IP identifier, wherein the UPF or the PGW identify a second non-IP identifier of the UE based on information associating the second non-IP identifier of the UE with the IP address of the UE.

14. The device of claim 13, wherein the second non-IP identifier includes at least one of:
an International Mobile Subscriber Identity (“IMSI”),
an International Mobile Station Equipment Identity (“IMEI”),
a Subscription Permanent Identifier (“SUPI”), or
a Globally Unique Temporary Identifier (“GUTI”).

15. A device, comprising:
one or more processors configured to:
maintain a set of policies associated with non-Internet Protocol (“IP”) messaging;
maintain information associating an IP address of a User Equipment (“UE”) with a non-IP identifier of the UE;
receive first traffic, that includes:
the IP address of the UE as a source of the first traffic, and
first payload information;
identify, using the maintained information associating the IP address of the UE with the non-IP identifier of the UE, the non-IP identifier of the UE based on the IP address of the UE included in the first traffic;
identify that the first traffic is associated with a first policy of the set of policies;
forward second traffic, including the first payload information and the non-IP identifier of the UE, to a destination device indicated in the first traffic,
wherein forwarding the second traffic includes implementing the first policy with respect to the second traffic;
receive third traffic, that includes:
the non-IP identifier of the UE as a destination of the third traffic, and
second payload information;
identify, using the maintained information associating the IP address of the UE with the non-IP identifier of the UE, the IP address of the UE based on the non-IP identifier included in the third traffic;
identify that the third traffic is associated with a second policy of the set of policies; and
forward fourth traffic, including the second payload information and the IP address of the UE, to one or more devices that route the fourth traffic to the UE,
wherein forwarding the fourth traffic includes implementing the second policy with respect to the fourth traffic.

16. The device of claim 15, wherein implementing the first policy includes buffering the second traffic with other traffic received over a particular time window, and forwarding the second traffic and the other traffic after the particular time window has elapsed.

17. The device of claim 15, wherein implementing the first policy includes performing a filtering operation on the first or second traffic.

18. The device of claim 15, wherein the non-IP identifier of the UE includes a Mobile Directory Number (“MDN”) of the UE.

19. The device of claim 15, wherein the first traffic is received from at least one of:
a User Plane Function (“UPF”), or
a Packet Data Network (“PDN”) gateway (“PGW”).

20. The device of claim 15, wherein forwarding the fourth traffic includes forwarding the fourth traffic to at least one of:
a User Plane Function (“UPF”), or
a Packet Data Network (“PDN”) gateway (“PGW”).
